(19) United States
(12) Patent Application Publication
(10) Pub. No.: US 2014/0265023 A1
(43) Pub. Date: Sep. 18, 2014

(54) Die Reduction Machine, Reducing Die, and Method of Installation for a Pipe Liner

(71) Applicant: SAK Construction, LLC, O'Fallon, MO (US)

(72) Inventor: James H. Blasczyk, Friendswood, TX (US)

(73) Assignee: SAK Construction, LLC, O'Fallon, MO (US)

(21) Appl. No.: 14/212,055

(22) Filed: Mar. 14, 2014

Related U.S. Application Data
(60) Provisional application No. 61/784,676, filed on Mar. 14, 2013.

(51) Int. Cl. B29C 63/34; B66F 19/00; B29C 67/00

(52) U.S. Cl. CPC B29C 63/34; B29C 67/0014; B66F 19/00; B29C 2063/348
USPC 264/280; 425/392; 254/29 R

(57) ABSTRACT

Systems and methods for reducing the diameter of a pipe liner to repair a damaged pipe, including means of reducing the pulling force required. This is done through use of a multi-section reduction die using a two-step reduction and pushing means for advancing the non-reduced liner portion into the die.

### CROSS REFERENCE TO RELATED APPLICATIONS

This application claims benefit of U.S. Provisional Patent Application No. 61/784,676, filed Mar. 14, 2013, the entire disclosure of which is incorporated herein by reference.

### BACKGROUND

1. Field of the Invention

This disclosure is related to the field of pipe reduction systems, specifically to pipe reduction systems which use a rigid die to compress a plastic pipe liner for insertion into an existing pipe.

2. Description of the Related Art

Over time, the underground pipelines utilized for the transport of fluids or gases or other elements can become damaged, worn or corroded from use. In the past, the methodologies utilized for rehabilitating these underground or underwater pipelines were costly, labor intensive, and severely disruptive to the surrounding environment and communities.

Today, one of the primary methods and systems utilized in the prior art for rehabilitating existing pipeline systems and networks and to avert these problems is to line an existing pipeline with an extremely tight fitting polyethylene (PE) liner. In such a process, the liner has an outside diameter that is slightly larger than the inside diameter of the pipe being lined. Because of the difference in diameter between the liner and the existing (host) pipeline, the liner is pulled through a die to reduce its diameter before it enters the existing pipeline.

Generally, the liner is pulled through the die after sections of the liner are butt fused together to form a continuous string. The die temporarily reduces the diameter of the liner. This reduction allows the liner to be easily pulled through the host. The die used in the prior art systems generally has an entry, a throat and an exit, with the entry decreasing in diameter towards the throat and increasing in diameter away from the throat. Thus, the liner has a maximum diameter before the die, a minimum diameter in the die, and an intermediate diameter after the die. In some embodiments, a heating element is used to apply heat to the liner prior to the liner being reduced in the die, the heating element being used to facilitate the reduction of the liner. This is, however, generally less preferred.

The tension given to the liner by the die is generally maintained by a pulling element until the liner is correctly located within the installed pipeline. Commonly, the liner is pulled through the die and the existing pipe system by a winch or towing head. Generally, the force of pulling rendered by the winch or towing head is half the yield strength of the liner or less. It is not uncommon for the forces exerted on the die and winch or pulling head to be very large, often exceeding 100 tons.

Since the liner retains a memory of its original shape and size, it will begin to return to its original shape and diameter as soon as the pulling force is disconnected. After the pulling force is disconnected, the liner relaxes over time and presses tightly against the inside of the existing host pipeline to which it was applied, minimizing the annular space.

Although the prior art processes held numerous benefits for the industry including reducing disruption, creating a strong new pipe, jointless construction, improved flow, and cost savings, they also have numerous deficiencies in terms of costs, safety and efficiency. For example, due to the large force vectors exerted in the prior art systems, massive ground anchors have to be utilized for both the die and the pulling head in order to withstand these forces. These anchoring systems can be cumbersome, costly, not readily transportable, and inefficient.

Another problem with the currently utilized methodology arises from the use of a single reducing die mechanism. Fully reducing the liner in a single step often results in extreme point friction on the liner in addition to strain on the liner and joints. This strain and friction often results in mechanical failure of the liner both pre- and post-insertion, particularly at the joints between adjacent pieces.

Still another problem in the current methodology is post-release creep. After the tension in the system is released, it is not uncommon for the inserted liner to creep or shrink more than expected. Generally, this gradual creep continues for a significant period of time after the insertion and release of the liner. This continued moving and pulling of the inserted liner out of its fittings is problematic because it results in a misformed pipe liner that is susceptible to potential leaks.

In die reduction systems of the prior art, the die reducing head (and thus the die reduction machine mounting the head) also have traditionally been mounted in a trench immediately in front of the access point of the pipe to be lined. Such an arrangement, with equipment in trenches at both ends, is described in U.S. Pat. No. 5,522,678 and U.S. Pat. No. 5,580,589, the entire disclosures of which are herein incorporated by reference.

Mounting in the trench (or “chamber” in the words of the above patents) has been used so that the liner for the pipe, after being diameter reduced, is fed linearly and generally co-axially into the pipe without needing to bend. As the liner is under immense tension after it has been reduced, it was generally preferred that it not be bent after the tension was imposed. Further, to keep the liner from relaxing prior to entering the pipe, it was generally preferred that the die reduction machine be placed as close as possible to the pipe access. It is known that after the liner leaves the die reduction machine, it will expand a little back toward its original size.

However, placing the die reduction machine in a trench provides a number of problems. One such problem is that the un-reduced liner being fed into the die reduction machine often has to feed through two relatively sharp bends to get into the trench. The first is at the top of the trench, when the liner enters the trench. The second is at the bottom of the trench when the liner needs to be straightened to enter the die. These bends are often sharp because the trench is of fairly limited length and is often not much longer than the die reduction machine itself. It takes time and money to excavate the trench and it is generally undesirable to make the trench longer than need be. Further, as the pipe to be lined will often be in a developed area, a larger trench causes more infrastructure damage tearing up roads, yards, and other infrastructure to make room for the trench. The bottom of the trench on the insert end of the pipe is typically excavated 1′ in length for every inch diameter of the liner being inserted. Thus, an 18″ liner will require an 18′ bottom in the trench. The tail ditch (a slanted back wall of the trench) will then be excavated at a 2 to 1 slope to the ground surface. Thus, if the pipe is at a 10′ depth, the tail ditch will be 20′ long. This construction is used as it typically reduces any excessive bending in the pipe as it goes into the trench.

Moreover, pulling the un-reduced liner through these bends presented other additional problems. One of which was making the liner line up with the die so it was entering the die linearly to make sure the liner was correctly reduced in size and no point suffered undue strain. To deal with this, complicated roller apparatus, such as that described in U.S. Pat. No. 5,580,589 were used to change the angle and direction of the un-compressed liner. These systems, however, are cumbersome and prone to breakage.

Such systems also exacerbated a second problem which was that there was limited space in the trench for the machinery. As indicated above, the trench is preferably smaller to reduce the infrastructure impact, time, and cost in building it. Thus, the trench was regularly filled with machinery in very close proximity to the walls and other structures. Further, the trench is also often filled with anchors, braces, and other supports to maintain the trench. This is as discussed in U.S. Pat. No. 5,522,678.

Yet another problem with this arrangement is the proximity of the die reduction machine to the access end of the pipe. Once the liner has been positioned, it is necessary to release the tension on the liner to allow it to relax. As the liner relaxes, it reduces in length as discussed above. Because the die reduction machine is right at the access entrance to the pipe, the die reduction machine generally cannot be removed prior to the relaxation being functionally completed, otherwise the end of the liner at the die reduction machine may get pulled into the pipe. Effectively, this arrangement forces the pipe to relax entirely from one end.

Because of this, the tension imparted by the die reduction machine to the liner is generally not released by gradually withdrawing the liner. Instead, when it is necessary to remove the remaining liner from the die reduction machine, the liner and die are still under tension. Releasing this tension in a confined area is dangerous as the machine (and the die halves) could suddenly lurch, move, or jump and pin or crush a worker, who has to be in the trench with the machine to release the tension. Further, parts of the die could become airborne and the liner itself could lurch around.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein is a die reduction machine which eliminates a number of the problems with prior art die reduction machines. Described herein, among other things, is a die reduction machine comprising: a first reduction section generally in the configuration of an annular conical frustum and disposed upon a die reduction frame, the first reduction section comprising: a first entrance side having a first entrance diameter; a first exit side having a first exit diameter; and a second reduction section generally in the configuration of an annular conical frustum and disposed upon the die reduction frame generally coaxially with the first reduction section, the second reduction section comprising: a second entrance side having a second entrance diameter; a second exit side having a second exit diameter; wherein the second reduction section is disposed such that a pipe liner exiting the first reduction section at the first exit side enters the second reduction section at the second entrance side.

In an embodiment, there is an open space between the first reduction section and the second reduction section.

In another embodiment, a tapered cylindrical enclosure extends from the first exit side to the second entrance side.

In another embodiment, the second reduction section is adjacent to the first reduction section.

In another embodiment, the second entrance diameter is greater than the first exit diameter.

In another embodiment, the first entrance diameter is about the diameter of a liner to be diameter-reduced using the die reduction machine and the second exit diameter is about the desired diameter of the liner after diameter-reduction using the die reduction machine.

Also described herein, among other things, is a pushing mechanism for use with a die reduction machine comprising: a grasping means for grasping a non-reduced section of a liner; and a pushing means for pushing a grasped non-reduced section of a liner toward a die reduction section.

In an embodiment, the grasping means is selected from the group consisting of one or more elongated friction clamps, one or more high-friction rollers, and temporary heat welds.

In another embodiment, the pushing means is a track-mounted crawler movable by a motive force.

In another embodiment, the motive force is selected from the group consisting of a hydraulic piston, a pneumatic piston, a ratcheting gear drive, and an electric motor.

In another embodiment, the grasping means is attached to the track-mounted crawler.

In another embodiment, the grasping means is moveable toward and away from the center axis of the non-reduced section of a liner using a secondary movement mechanism.

In another embodiment, the grasping means and the pushing means are one or more high-friction rollers.

Also described herein, among other things, is a method for reducing the amount of pulling force required for pulling a liner through a diameter-reducing die comprising: providing a die reduction machine comprising: a first reduction section disposed on a frame; a track-mounted crawler disposed on the frame and movable on the track by a motive force; one or more elongated friction clamps disposed on the track-mounted crawler, the elongated friction clamps moveable toward and award from the center axis of a liner section disposed in the die reduction machine; providing a liner; providing a towing head threaded through the first reduction section and attached to the liner; the towing head pulling the liner through the die reduction machine; moving the crawler to a track position farthest from the first reduction section; moving the one or more elongated friction clamps toward the center axis of the liner until the elongated friction clamps engage the liner; the motive force moving the crawler toward the first reduction section; and the elongated friction clamps engaged with the non-reduced liner pushing the liner toward the first reduction section and thereby reducing the amount of pulling force required for the towing head to pull the liner through the first reduction section.

In an embodiment, the motive force is selected from the group consisting of a hydraulic piston, a pneumatic piston, a ratcheting gear drive, and an electric motor.

In another embodiment, the required pulling force is reduced by an amount sufficient for the die reduction machine to be anchored by a skid mount.

In another embodiment, the required pulling force is reduced by an amount sufficient for the die reduction machine to be mounted to a flatbed trailer and anchored by the mass of the flatbed trailer.

In an embodiment, the required pulling force is reduced by an amount sufficient for the die reduction machine to be mounted to a flatbed trailer and anchored by the mass of the flatbed trailer when the wheels of the flatbed trailer are chocked.

In an embodiment, the die reduction machine further comprises a second reduction section disposed on the frame generally coaxially with the first reduction section such that the liner enters the second reduction section after exiting the first reduction section; and the provided towing head is threaded through the first reduction section and the second reduction section.

In an embodiment, when the die reduction machine reduces the diameter of the liner, the die reduction machine is above grade from a generally subterranean pipe to be lined by the liner.

### BRIEF DESCRIPTION OF THE DRAWING

FIG. 1 depicts a conceptual image of an embodiment of a die reduction machine positioned on the ground.

FIG. 2A provides a photo of a die reduction machine braced in place above ground. FIG. 2B provides a photo of a die reduction machine chained in place above ground.

FIG. 3 depicts an embodiment of a die reduction machine including a push mechanism.

FIG. 4 depicts a conceptual image of an embodiment of a die reduction machine mounted on a flatbed trailer.

FIG. 5 depicts an embodiment of a double reducing die.

### DESCRIPTION OF THE PREFERRED EMBODIMENT(S)

The following detailed description and disclosure illustrates by way of example and not by way of limitation. This description will clearly enable one skilled in the art to make and use the disclosed systems and apparatus, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

In the first instance, there is provided herein a method of placing the die reduction machine above ground instead of in a trench. This allows elimination of the sharp bend in the non-reduced liner (and the associated roller mechanisms) necessary to linearly enter the die reduction machine at the bottom of the trench. Secondly, the die reduction machine can be modified to internally push the liner into the die, this eliminates some of the external tension imparted on the die reduction machine by the pulling winch. Finally, two separate reducing dies are used to decrease the tension imparted by either one die and reduce potential points of high spot tension.

FIG. 1 shows an embodiment of a die reduction machine (101) which is located above ground. Specifically, it rests on the ground (103) and is not in a trench (105). This arrangement can be used with the die reduction machine (901) discussed below, or can alternatively be used with traditional style machines. The die reduction machine (101) is preferably positioned at least 75 feet back from the access point (113) of the pipe (111) that the liner (301) is being placed in. However, this distance is by no means determinative and the desired distance will generally depend on the pipe (111) diameter and the length of the run that the liner (301) is being placed into. In general, the larger the diameter of the pipe (111), the further the die reduction machine (101) is placed from the access point (113). More specifically, the die reduction machine (101) will generally be placed a distance away from the access point (113) greater than the distance the liner (301) is expected to shrink when it relaxes. The die reduction machine (101) may be chained down or otherwise secured as shown in FIGS. 2A and 2B.

Once positioned, the liner (301) may be run through the die reduction machine (101) in the same manner as a traditional reduction system. The reduced liner (301B) is pulled at a shallow angle toward the trench (105) by a forward winch chained or otherwise connected to a towing head (303) which has been butt welded to the liner (301). The reduced liner (301B) enters the trench (105), and is then allowed to enter the pipe (111). It should be recognized that the reduced liner (301B) may enter the pipe (111) at a slight angle (e.g. not co-axially). As the reduced liner (301B) is smaller in diameter than the pipe (111), the reduced liner (301B) will generally not scrape on an upper surface of the access point (113) due to the difference in diameter.

In certain scenarios, in order to facilitate the reduced liner (301B) entering the pipe (111), the trench (105) may include a ramped (or angled) back wall (115) which allows the trench (105) to taper downward with the liner (301B). This design can also facilitate digging the trench (105), as it provides ready access for digging machines, but may require more space than is available.

One of the advantages of not having the die reduction machine (101) in the trench (105) is that the confined space around the die reduction machine (101) is not present. Thus, when tension is released on the liner (301B), even if the die reduction machine (101) lurches or jumps there is plenty of space for a worker to avoid it. A second advantage is that once the liner (301) has been mostly positioned, and it is time to release the tension, there is no need to hold the tail end (331) of the liner (301A) rigidly in position. As the liner (301B) re-expands, the liner (301B) can be allowed to shorten from both ends.

As should be apparent, it is a huge problem if either end of the liner (301) retracts into the pipe (111). If the tension on the liner (301A) from the die (151) is released prior to the liner (301B) having almost completely relaxed and the tail end (331) is too close to the access point (113), the liner (301) risks the likely possibility of being pulled into the pipe (111). As the die reduction machine (101) is much closer to the access point (113) if it is in the trench (105) than in the embodiment of FIG. 1, when the die reduction machine (101) is in the trench (105), the die (151) will always be under pressure from the liner (301A), even after the liner (301B) has fully expanded inside the pipe (111). Thus, the die (151) is always released under pressure.

In the embodiments of FIGS. 1, 2A, 2B, and 4, the liner (301B) may actually be cutoff prior to it entering the die (151) once a sufficient amount of liner (301B) has been obtained at the far end of the pipe (111). Ideally, once cut, the tail end (331) of the liner (301A) is immediately prior to the back opening (153) of the die (151) when tension is released (such as by letting back on the winch). The liner (301B) is then allowed to naturally re-expand. Generally, the remaining force on the liner (301B) is sufficient to pull the tail end (331) of the liner (301A) through the die (151). In this way, the gradual release of tension in the liner (301B) can pull the last part of the liner (301A) through the die (151) and release the tension on the die (151) without any need of a worker releasing it. This means that workers do not need to be in proximity to the die (151) when the tension releases and there is no need to open the clamshell structure of the die (151) to release the tension.

Still further, as the die reduction machine (101) is set such a great distance from the access point (113), the tail end (331) can be allowed to contract toward the access point (113) without concern of it going internal to it. Thus, the die reduction machine can be removed well before the re-expansion of the liner (301B) is complete.

FIG. 3 provides for an advanced die reduction machine (901) which utilizes a “push/pull” arrangement to reduce the need to mount the die reduction machine (901) strongly to the ground in the manner of FIG. 2A or 2B. Normally, as the liner (301B) will have multiple tons of force being applied to the front end, that force is transferred to the die (151) and thus the die reduction machine (101) by the liner (301A) being forced into the die (151). Thus, if the die reduction machine (101) is not rigidly attached to the earth to transfer that force to the surrounding earth or related structure, the die reduction machine (101) will simply slide across the ground and no reduction to the liner (301A) will occur. To hold the die reduction machine (101) in place, devices such as the massive wooden buttresses of FIG. 2A or the logging chains of FIG. 2B were required.

In the die reduction machine (901) of FIG. 3, the traditional components of the liner (301), both the non-reduced liner (301A) portion and the reduced liner (301B) portion, are shown. As expected, the towing head (303) and the chain, cable (305), or other object for connecting to the winch are present. Further, there is a reducing die (951) which may be the double die (400) of FIG. 5 as shown, or may be a single die (151) of the type known to the prior art. The liner (301) is also under a large amount of tension as would be expected from force applied by the winch pulling the towing cable (305). The die reduction machine (901) also includes a traditional mounting frame (909) which is generally of parallelepiped structure.

The die reduction machine (901) of FIG. 3, however, also includes a pushing mechanism (905) which is internal to the frame (909) and is generally mounted thereon. The pushing mechanism (905) may be any form of mechanism which is designed to grasp the non-reduced liner (301A) and push it toward the die (951). In the depicted embodiment, it comprises a series of elongated friction clamps (971) which are mounted to a crawler (975) having a fixed track (973). The motion of the crawler (975) on the track (973) may be produced through any form of motive force including, but not limited to, attaching a hydraulic or pneumatic piston to the crawler (975), or by having the crawler (975) utilize a ratcheting gear drive and electric motor (a cog setup).

Regardless of how it operates, the elongated friction clamps (971) will generally be moveable toward and away from the center axis of the non-reduced liner (301A) via a secondary movement mechanism which may be of a similar style to that used by the crawler (975). To utilize the pushing mechanism (905), the crawler (975) will be placed at the portion of the track (973) furthest from the die (951) and the elongated friction clamps (971) will be pushed in toward the non-reduced liner (301A). The elongated friction clamps (971) will contact the outer surface of the non-reduced liner (301A) and engage it with a strong frictional bond. Alternative bonds such as temporary heat welds may also be used instead of friction, but those are generally less preferred as they may weaken the structure of the liner (301A).

The crawler (975) will then be engaged to move toward the die (951) and the force of the movement of the crawler (975) will be transferred to the liner (301A) by the friction from the friction clamps (971). From this force, the liner (301A) will at least be partially pushed into the die (951). Once the crawler (975) reaches the end of the track (973) closest to the die (951), the friction clamps (971) will briefly disengage, and the crawler (975) will return to its starting point, and reengage a new section of the liner (301A), repeating the above steps.

In an alternative embodiment, the frictional clamps (971), crawlers (975), and tracks (973) may be replaced by a series of high friction rollers. In this case, the individual rollers will all engage the outer surface of the liner (301A) and will slowly rotate at the same speed to again push the liner (301A) toward and into the die (951). However, in this case, there is no need to have the temporary release and return movement discussed above.

As should be apparent, by including a force pushing the liner (301A) into the die (951), the force of the tension on the die (951) from pulling the reduced liner (301B) is reduced. It can potentially be reduced to nothing if the various push and pull forces are in appropriate balance. It should be recognized, however, that if the pushing force is too great compared to the pulling tension, it is possible that the non-reduced liner (301A) could become “bunched up” or wrinkled prior to the die (951). For this reason, the tension from the cable (305) still must be sufficient to make sure that the liner (301A) is proceeding through the die (951) in an orderly fashion.

An advantage of reducing the amount of force imposed on the die reduction machine (901) from the winch and chain (305) is that the die reduction machine (901) will generally not require as much bracing in order to keep it stable. This, combined with the above ground mounting of FIG. 1, provides for alternative ways of positioning the die reduction machine (901) at the job site. As the die reduction machine (901) is not located in the trench (105), it may be much larger and therefore have a longer push run prior to the die (951). Also, since it does not need to be staked down, it may be provided on an alternative transport.

In FIG. 3, the die reduction machine (901) is provided on a skid mount (991) which can simply be carried by a piece of construction equipment and rested on the ground (103) wherever it is needed. In a still further embodiment, as shown in FIG. 4, the die reduction machine (901) it may be mounted on a flatbed truck trailer (503). Both of these arrangements allow for the die reduction machine (901) to be highly transportable and allow it to be used virtually anywhere as its presence will generally not damage infrastructure since it does not have to be staked down. The trailer (503) can be particularly beneficial as the simple mass of the trailer (503) may be sufficient to keep it from moving if the wheels are properly locked and chocked.

In order to further decrease the amount of tension which is applied to both the liner (301A) and the die (951), the die (951) may be modified to be a two-part die (400) having two longitudinal parts (401) and (403) as shown in FIG. 5, each of which may or may not be of a two part clamshell design. Specifically, the two-part die (400) has two different sections of reduction, a first section (401) and a second section (403). Depending on the embodiment, how the sections (401) and (403) are used and the amount of reduction applied by each will change.

In the embodiment of FIG. 5 where the dies are separated by an open space (405), the first die (401) will generally provide a first reduction from a starting entrance size (411) of non-reduced liner (301A) to an intermediate sized liner (301C) of generally the exit size (421). Because of the space (405) however, the intermediate liner (301C) will generally expand in the space (405). Thus, the entrance size (413) of the second die (403) may be greater than the exit size (421) of the first die (401). The exit size (423) of the second die (403) will generally result in a final reduced liner (301B) of the same size as would be obtained in the use of a single die (151).

In an alternative embodiment, the space (405) may be removed by moving the two die sections (403) and (401) to touch each other or by reducing the space (405) a sufficient amount to not allow the intermediate liner (301C) to appreciably relax. In a still further embodiment, the space (405) may actually be filled by a cylindrical or nearly cylindrical tapered section connecting entrance (413) to exit (421). In this arrangement, the intermediate liner (301C) will not be allowed to expand at all, but has very little tension applied at any particular point.

It should be recognized that regardless of the arrangement of the dies (401) and (403), the angle and amount of reduction in the dies (401) and (403) may be the same (e.g. each reduces the diameter of liner (301A) or (301C) by 1 inch). This allows for a simple two step step-down of the size. In an alternative embodiment, the dies (401) and (403) may be different and a greater reduction may be provided by either one of the dies (401) or (403) in order to reduce tension. Further, each of the dies (401) and (403) may be constructed in the form of two clamshell halves as discussed above to allow for them to be opened to remove the liner (301) therefrom for any reason. This can allow the dies (401) and (403) to be removed even while liner (301) is tensioned within them and thus, the two part die can be used in a die reduction machine which is intended to be positioned in the trench (105).

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A die reduction machine comprising:
a first reduction section generally in the configuration of an annular conical frustum and disposed upon a die reduction frame, said first reduction section comprising:
a first entrance side having a first entrance diameter;
a first exit side having a first exit diameter; and
a second reduction section generally in the configuration of an annular conical frustum and disposed upon said die reduction frame generally coaxially with said first reduction section, said second reduction section comprising:
a second entrance side having a second entrance diameter;
a second exit side having a second exit diameter;
wherein said second reduction section is disposed such that a pipe liner exiting said first reduction section at said first exit side enters said second reduction section at said second entrance side.

2. The die reduction machine of claim 1, wherein there is an open space between said first reduction section and said second reduction section.

3. The die reduction machine of claim 1, wherein a tapered cylindrical enclosure extends from said first exit side to said second entrance side.

4. The die reduction machine of claim 1, wherein said second reduction section is adjacent to said first reduction section.

5. The die reduction machine of claim 1, wherein said second entrance diameter is greater than said first exit diameter.

6. The die reduction machine of claim 1, wherein said first entrance diameter is about the diameter of a liner to be diameter-reduced using said die reduction machine and said second exit diameter is about the desired diameter of said liner after diameter-reduction using said die reduction machine.

7. A pushing mechanism for use with a die reduction machine comprising:
a grasping means for grasping a non-reduced section of a liner; and
a pushing means for pushing a grasped non-reduced section of a liner toward a die reduction section.

8. The pushing mechanism of claim 7, wherein said grasping means is selected from the group consisting of one or more elongated friction clamps, one or more high-friction rollers, and temporary heat welds.

9. The pushing mechanism of claim 7, wherein said pushing means is a track-mounted crawler movable by a motive force.

10. The pushing mechanism of claim 9, wherein said motive force is selected from the group consisting of a hydraulic piston, a pneumatic piston, a ratcheting gear drive, and an electric motor.

11. The pushing mechanism of claim 9, wherein said grasping means is attached to said track-mounted crawler.

12. The pushing mechanism of claim 7, wherein said grasping means is moveable toward and away from the center axis of said non-reduced section of a liner using a secondary movement mechanism.

13. The pushing mechanism of claim 7, wherein said grasping means and said pushing means are one or more high-friction rollers.

14. A method for reducing the amount of pulling force required for pulling a liner through a diameter-reducing die comprising:
providing a die reduction machine comprising:
a first reduction section disposed on a frame;
a track-mounted crawler disposed on said frame and movable on said track by a motive force;
one or more elongated friction clamps disposed on said track-mounted crawler, said elongated friction clamps moveable toward and award from the center axis of a liner section disposed in said die reduction machine;
providing a liner;
providing a towing head threaded through said first reduction section and attached to said liner;
said towing head pulling said liner through said die reduction machine;
moving said crawler to a track position farthest from said first reduction section;
moving said one or more elongated friction clamps toward the center axis of said liner until said elongated friction clamps engage said liner;
said motive force moving said crawler toward said first reduction section; and
said elongated friction clamps engaged with said non-reduced liner pushing said liner toward said first reduction section and thereby reducing the amount of pulling force required for said towing head to pull said liner through said first reduction section.

15. The method of claim 14, wherein said motive force is selected from the group consisting of a hydraulic piston, a pneumatic piston, a ratcheting gear drive, and an electric motor.

16. The method of claim 14, wherein said required pulling force is reduced by an amount sufficient for said die reduction machine to be anchored by a skid mount.

17. The method of claim 14, wherein said required pulling force is reduced by an amount sufficient for said die reduction machine to be mounted to a flatbed trailer and anchored by the mass of said flatbed trailer.

18. The method of claim 17, wherein said required pulling force is reduced by an amount sufficient for said die reduction machine to be mounted to a flatbed trailer and anchored by the mass of said flatbed trailer when the wheels of said flatbed trailer are chocked.

19. The method of claim 14, wherein:
said die reduction machine further comprises a second reduction section disposed on said frame generally coaxially with said first reduction section such that said liner enters said second reduction section after exiting said first reduction section; and
said provided towing head is threaded through said first reduction section and said second reduction section.

20. The method of claim 14, wherein when said die reduction machine reduces the diameter of said liner, said die reduction machine is above grade from a generally subterranean pipe to be lined by said liner.
